(19) United States
(12) Patent Application Publication
(10) Pub. No.: US 2022/0152750 A1
(43) Pub. Date: May 19, 2022

(54) INTERLINER FOR ROLL BONDED BRAZING SHEET

(71) Applicant: ARCONIC TECHNOLOGIES LLC, Pittsburgh, PA (US)

(72) Inventors: Tao ZHOU, Lancaster, PA (US); Stephen F. BAUMANN, Lancaster, PA (US); Baolute REN, Lititz, PA (US)

(21) Appl. No.: 17/594,213

(22) PCT Filed: Apr. 24, 2019
(86) PCT No.: PCT/US2019/028824

§ 371 Date: Oct. 7, 2021

(51) Int. Cl. B23K 35/02; B32B 15/01; B23K 35/00; B23K 35/28; B23K 20/04; C22C 21/02

(52) U.S. Cl. CPC B23K 35/0238; B32B 15/016; B23K 35/002; B23K 2101/14; B23K 20/04; C22C 21/02; B23K 35/288

(57) ABSTRACT

An apparatus, material and method for forming a reliably roll-bonded, multi-layer aluminum alloy brazing sheet has a core of 2XXX, 3XXX, 5XXX or 6XXX alloy, a braze liner of 4XXX alloy and an interliner with Mn in the range of 0.2 to 1.0 wt. % and Si in the range of 0.31-1.0 wt. %. Alternatively, Mg in the range of 0.1 to 0.5 wt. % may be present in the interliner. Additional layers such as a second braze liner may be present for providing an inner surface of a heat exchanger. An additional interliner may optionally be used between the core the inner surface layer. The material may be used for highly corrosive environments like an EGR cooler.

### FIELD

The present invention relates to brazing sheet materials, heat exchangers, methods for making same and more particularly, to multi-layer aluminum alloy brazing sheet that is formed by roll bonding.

### BACKGROUND

Roll-bonded, multi-layer brazing sheet materials are known wherein multiple layers of different aluminum alloys, e.g., for forming a core, a braze liner and an interliner, are stacked and passed through a rolling mill. Typically, the stack of layers is pre-heated and the rolling mill exerts high pressure on the stack, causing the stack to be reduced in cumulative thickness, as well as reducing the thickness of the individual layers. The rolling process and reduction in thickness also cause the individual layers to bond to one another, yielding a single composite sheet of reduced thickness with a plurality of layers. An interliner/interliner layer may be used in a multi-layer brazing sheet to reduce migration of elements, e.g., between the core and the braze liner during brazing that leads to diminished corrosion resistance. Under a low pH environment such as an EGR (exhaust gas recirculation) related CAC (charge air cooler), the core materials can be easily susceptible to corrosion such as intergranular corrosion without the protection of interliners. Known interliners, such as alloy 0140 available from Arconic, Inc. of Pittsburgh, Pa., U.S.A. or AA1145, sometimes exhibit difficulty in bonding to adjacent layers when roll bonded to form a laminate. Notwithstanding known methods, materials and apparatus, alternative methods, apparatus and materials for making multi-layer, roll-bonded brazing heat material remain desirable.

### SUMMARY

The disclosed subject matter relates to a multi-layer sheet material, having:

core of one of 2XXX, 3XXX, 5XXX or 6XXX aluminum alloy; a braze liner of 4XXX aluminum alloy; and an interliner having a composition of: 0.31-1.0 wt. % Si, <0.1 wt. % Mg, 0.25-1.0 wt. % Mn, up to 5.0 wt. % Zn, up to 0.3 wt. % Fe, up to 0.2 wt. % Cu, up to 0.125 wt. % Zr, other elements ≤0.05 wt. % each and ≤0.15 wt. % total, balance Al.

In another embodiment, the interliner contains 0.34-0.5 wt. % Si, <0.05 wt. % Mg and 0.25-0.35 wt. % Mn, ≤0.05 wt. % Zn, ≤0.3 wt. % Fe, ≤0.05 wt. % Cu.

In another embodiment, the interliner is disposed between the braze liner and the core.

In another embodiment, the interliner contains 0.4-0.5 wt. % Si.

In another embodiment, the interliner contains 0.25-0.34 wt. % Mn

In another embodiment, the interliner further comprises 0.05-5.0 wt. % Zn.

In another embodiment, an increase in flow stress in the interliner attributable to the presence of at least one of Mg and Mn is in the range of 20% to 52% over the flow stress in the interliner without the presence of at least one of Mg and Mn.

In another embodiment, the core is a 3003 aluminum alloy.

In another embodiment, the core comprises 0.1 to 1.0 wt. % Si; up to 0.5 wt. % Fe, 0.2 to 1.0 wt. % Cu; 1.0 to 1.5 wt. % Mn, 0.2 to 0.3 wt. % Mg; up to 0.05 wt. % Zn and 0.1 to 0.2 wt. % Ti.

In another embodiment, the braze liner comprises: 6.8 to 8.2 wt. % Si; up to 0.8 wt. % Fe, up to 0.25 wt. % Cu; up to 0.1 wt. % Mn and up to 0.2 wt. % Zn.

In another embodiment, further including another liner disposed on the core distal to the interliner and the braze liner.

In another embodiment, the another liner includes a second braze liner and a second interliner, the second interliner disposed between the core and the second braze liner.

In another embodiment, the interliner contains 0.34 to 0.5 wt. % Si, up to 0.1 wt. % Zn and further comprises up to 0.3 wt. % Fe and up to 0.2 wt. % Cu, balance Al and other elements <0.05 wt. % each, 0.15 wt. % total.

In another embodiment, the interliner contains <0.05 wt. % Cu and further comprising up to 0.125 wt. % Zr.

In another embodiment, the sheet material has a total thickness of from 0.1 mm to 3.0 mm with a core thickness of 0.09 mm to 2.85 mm, the braze liner having a clad ratio of 2.5% to 20% and the interliner having a clad ratio of 2.5 to 20%.

In another embodiment, the sheet material is O temper.

In another embodiment, a heat exchanger has at least one of a tube, a fin, a header plate or a tank with a sheet material having core of one of 2XXX, 3XXX, 5XXX or 6XXX aluminum alloy; a braze liner of 4XXX aluminum alloy; and an interliner having a composition of: 0.31-1.0 wt. % Si, <0.1 wt. % Mg, 0.25-1.0 wt. % Mn, other elements ≤0.05 wt. % each and ≤0.15 wt. % total, balance Al.

In another embodiment, a multi-layer sheet material, has a core of one of 2XXX, 3XXX, 5XXX or 6XXX aluminum alloy; a braze liner of 4XXX aluminum alloy; and

an interliner with 0.31-1.0 wt. % Si, 0.1-0.5 wt. % Mg, 0.05-0.3 wt. % Mn, up to 5.0 Wt. % Zn, other elements ≤0.05 wt. % each and ≤0.15 wt. % total, balance Al.

In another embodiment, the interliner contains 0.05-5.0 wt. % Zn.

In another embodiment, a method for making a brazing sheet includes the steps of:

providing a layer of interliner comprising 0.31-1.0 wt. % Si; <0.1 wt. % Mg; 0.25-1.0 wt. % Mn; providing a layer of core material selected from one of 2XXX, 3XXX, 5XXX or 6XXX aluminum alloy; providing a layer of braze liner material of 4XXX aluminum alloy; stacking the layer of interliner, the layer of core material and the layer of braze liner material into a stack with the interliner disposed between the layer of core material and the layer of braze liner material; and rolling the stack to form a bonded multi-layer brazing sheet.

### BRIEF DESCRIPTION OF THE DRAWINGS

For a more complete understanding of the present disclosure, reference is made to the following detailed description of exemplary embodiments considered in conjunction with the accompanying drawings.

FIG. 1 is a diagrammatic view of a brazing sheet in accordance with an embodiment of the present disclosure.

FIG. 2 is a diagrammatic view of a brazing sheet in accordance with another embodiment of the present disclosure.

FIG. 3 is a graph of stress versus strain for a plurality of materials.

FIG. 4 is a graph of flow stress versus strain rate for a plurality of materials.

FIG. 5 is a set of images of the microstructure of a plurality of post braze multilayer materials that were not pre-strained.

FIG. 6 is a set of images of the microstructure of a plurality of post braze multilayer materials that were pre-strained.

FIG. 7 is a graph of corrosion depth for a plurality of materials in response to corrosion testing.

### DETAILED DESCRIPTION OF EXEMPLARY EMBODIMENTS

An aspect of the present disclosure is the recognition that brazing sheet has several objectives, e.g., light weight, high strength and corrosion resistance and further that these attributes often are conflicting. For example, the use of 3XXX aluminum alloys for core layers of a brazing sheet contributes to the overall strength of the sheet material after brazing, but typical 4XXX braze liner will cause severe liquid film migration (LFM) upon brazing, leading to reduced corrosion resistance. This is particularly true with respect to O temper braze sheet (or brazing sheet) using 3XXX core and 4XXX braze liner (also known as a braze layer). Interliners (also known as an interlayer or interliner layer) made from high purity aluminum alloys, such as, Arconic alloy 0140, and AA1145 may be used as a protection layer, resulting in improved corrosion resistance, but such interliner materials sometimes result in roll bonding deficiencies, giving rise to delamination in whole or part (blistering) of the core and brazing layer at the interliner interface.

An aspect of the present disclosure is the recognition that high purity interliner alloys are soft, in particular, relative to core alloys, e.g., in the 2XXX, 3XXX, 5XXX and 6XXX alloy series, such as 3003 aluminum alloy, and/or 4XXX brazing alloys, such as 4047, 4045, 4343, 4147, 4004, 4104 alloys and derivatives of these alloys with zinc additions. Typical rolling temperature for multi-layer brazing products has a range between 700 to 1000° F. which can vary based on specific manufacturing processes and materials to be rolled. During rolling at this temperature range, large differences in flow stress of these alloys can cause materials to deform distinctly which presents challenges to forming bonded products. Flow stresses of these layers at the rolling temperature defines their mechanical behavior and are relevant to the rolling behavior and bondability.

An aspect of the present disclosure is the recognition that a smaller difference in flow stress of the various layers of a roll-bonded multi-layer sheet, e.g., the interliner relative to the core and/or braze liner, may give rise to better bonding between the multiple layers and that if the flow stress of layers of a multi-layer, roll bonded sheet are closer in value, the bonding produced by roll-bonding the multi-layer sheet will be facilitated. The term “bondability” may be used to designate the property of adjacent layers to be bonded together by roll bonding. For example, adjacent sheets that have higher bondability would more readily and/or more successfully bond to one another when roll bonded compared to adjacent sheets that have lower bondability.

An aspect of the present application is the recognition that the flow stress of a relatively soft layer in a multi-layer roll-bonded brazing sheet may be adjusted by adding elements that strengthen the soft layer to more closely approach the flow stress of other layers to which it is bonded and that this adjustment of hardness will improve the bondability of the previously softer layer.

An aspect of the present disclosure is the recognition that the strengthening of a soft layer in a multi-layer, roll-bonded brazing sheet will result in an increase in the flow stress. Further, that roll bonding is promoted when the flow stress of adjacent layers is closer in value to one another. With respect to an interliner layer made from, e.g., Arconic alloy 0140 (See Table 2, IL0), this alloy can be observed to have a flow stress of 1.25, 1.91 and 3.15 ksi at strain rates of 0.01. 0.1 and 1/second respectively at 900° F. (See Table 4 below). By comparison, the flow stress of a 3XXX core alloy, such as, 3003 has a flow stress of 2.09, 3.19, and 5.16 ksi at strain rates of 0.01. 0.1 and 1/second, respectively; a 4XXX brazing liner, such as, 4343 has as flow stress of 1.7, 2.62, and 4.55 ksi at strain rates of 0.01. 0.1 and 1/second, respectively (Table 4). By adding 0.2 to 0.3 wt. % of Mn to 0140 aluminum alloy (IL4, IL5, and IL6 of Table 2) , the flow stress can be increased to 1.72, 2.35 and 3.78 ksi to 1.9, 2.6 and 3.87 ksi for 0.01. 0.1 and 1/second, respectively, representing an increase in flow stress of between 20% and 52%. Further addition of 0.1 to 0.4 wt. % Mg to 0140 aluminum alloy (IL7, IL8 and IL10 alloy in Table 4) can increase the flow stress of the resultant alloys to higher levels. Good roll-bonding for multiple aluminum alloy layers requires breaking all surface aluminum oxides simultaneously so the aluminum underneath can bond metallurgically. When a softer interliner is used to make a multi-layer material, it can be deformed more easily, but both the harder braze liner and core alloy will have a relatively lower amount of deformation. The lower deformation of the braze liner and core is less effective in breaking down the surface oxides, making a good metallurgical bond with the interliner harder to form. In accordance with the present disclosure, to promote good bonding, a smaller difference in flow stress between layers is preferred. A closer matching of flow stresses between the interliner and the braze liner is beneficial for roll-bonding and helps to prevent blisters that are often found between the braze liner and interliner alloys in multi-layer braze sheets.

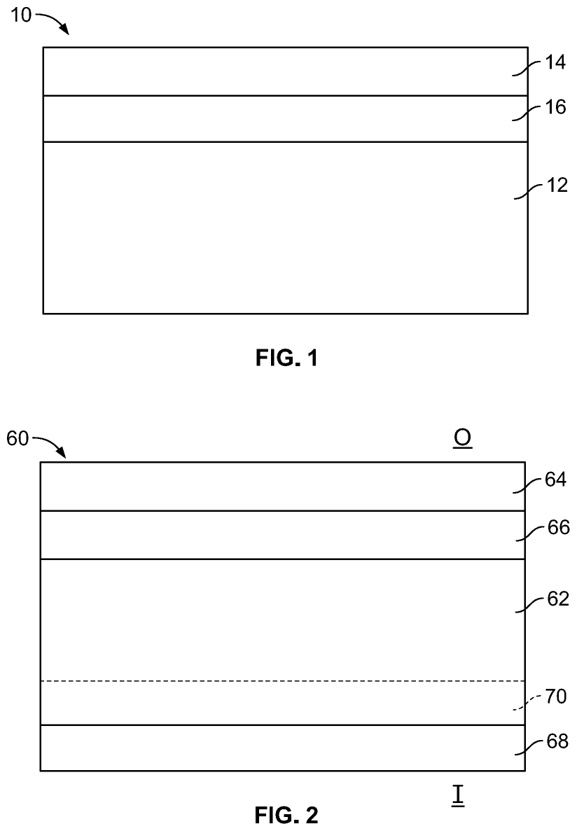

FIG. 1 shows a brazing sheet material 10 with an aluminum alloy core 12 of 3XXX series aluminum alloy, e.g., core B alloy in Table 1 below, Arconic alloy 0359, with the composition shown. In one embodiment, the core has a composition of ≤0.2 wt. % Si; ≤0.35 wt. % Fe, 0.4-0.6 wt. % Cu; 1.0-1.3 wt. % Mn, 0.2-0.3 wt. % Mg; ≤0.05 wt. % Zn, 0.1-0.2 wt. % Ti, the remainder Al and unavoidable impurities. The brazing sheet 10 of FIG. 1 includes a braze liner (layer) 14 having a base composition of 4XXX (4000) series aluminum alloy, e.g., 4343. In one embodiment, the braze liner 14 has a composition of 6.8-8.2 wt. % Si; ≤0.8 wt. % Fe, ≤0.25 wt. % Cu; ≤0.1 wt. % Mn, ≤0.2 wt. % Zn, the remainder Al and unavoidable impurities. An interliner (interliner layer) 16 is positioned between the core 12 and the braze liner 14. In one embodiment, the interliner 16 (IL0 in Table 2, 0140) has a composition of 0.34-0.5 wt. % Si; <0.3 wt. % Fe, <0.05 wt. % Cu; <0.1 wt. % Mn and <0.05 wt. % Mg; <0.1 wt. % Zn. In light of the presence of Mn and/ or Mg in the interliner 16, it could be described as a modified 1XXX series aluminum alloy. In one embodiment, a 0140 aluminum alloy may be modified by adding up to between 0.10 to 0.30 wt. % Mn or 0.10 to 0.40 wt. % Mg, alternatively or combined. Addition of up to 0.2 wt. % Cu and up to 0.125 wt. % Zr were also studied for their strengthening effects. In another embodiment, the interliner has 0.31-1.0 wt. % Si, up to 0.1 wt. % Mg and 0.25-1.0 wt. % Mn.

The brazing sheet material 10 has a range of thicknesses from 0.1 to 3 mm, with the core having a thickness of 0.1 to 2.85 mm, the braze liner a thickness of 0.005 to 0.6 mm or a clad ratio of 2.5 to 20% and the interliner a thickness from 0.005 to 0.6 mm (a clad ratio of 2.5 to 20%).

FIG. 2 shows a multi-layer (4 or 5 layers) brazing sheet 20 with a braze liner 64, an interliner 66, a core 62, another braze liner 68 and another interliner 70. The braze liners 64 and 68 may be made of 4XXX series aluminum alloys such as 4343, 4045 and 4047 alloys. The core 62 may be made of 2XXX, 3XXX and 6XXX alloys, such as a 3003 alloy. The interliners 66 and 70 may be made of high purity aluminum alloys with an amount of Mn and/or Mg, as described above. The braze liner 64 would typically be used to form the exterior surface of the structure formed from the brazing sheet 20 that intermediates between the interliner 66 and an outer environment O. An interliner 70 may be used to intermediate between the core 62 and an internal environment I of the structure formed from the brazing sheet 20 if there is no additional braze liner 68, which is optional. If present, the braze liner 68 would form the interior surface of the structure that intermediates between the interliner 70 and an inner environment I. Amounts of Mn of 0.25-1.0 wt. % or 0.25-0.35 wt. % wt. % in the interliners 66, 70 have shown dramatic increases of flow stress at the rolling temperature. The addition of 0.2 wt. % Mn also shows an effective increase of flow stress compared to a high purity interliner, such as interliner alloy IL0 (Table 2, below). In another embodiment, Si may be present in an amount of 0.4-0.5 wt. %.

In another embodiment, 0.10-0.5 wt. % Mg with or potentially without a small amount of Mn, i.e., from 0.05 to 0.3 wt. % can provide a beneficial effect similar to the presence of 0.25-1.0 wt. % Mn, as described above.

In another embodiment, an addition of up to 5 wt. % zinc can be added to an interliner alloy in accordance with the present disclosure to aid corrosion resistance without changing the flow stress and LFM behavior for the braze liner and interliners alloys herein. In one example, the internal environment I may be exhaust gas from in internal combustion engine and the outer environment O may be air or coolant.

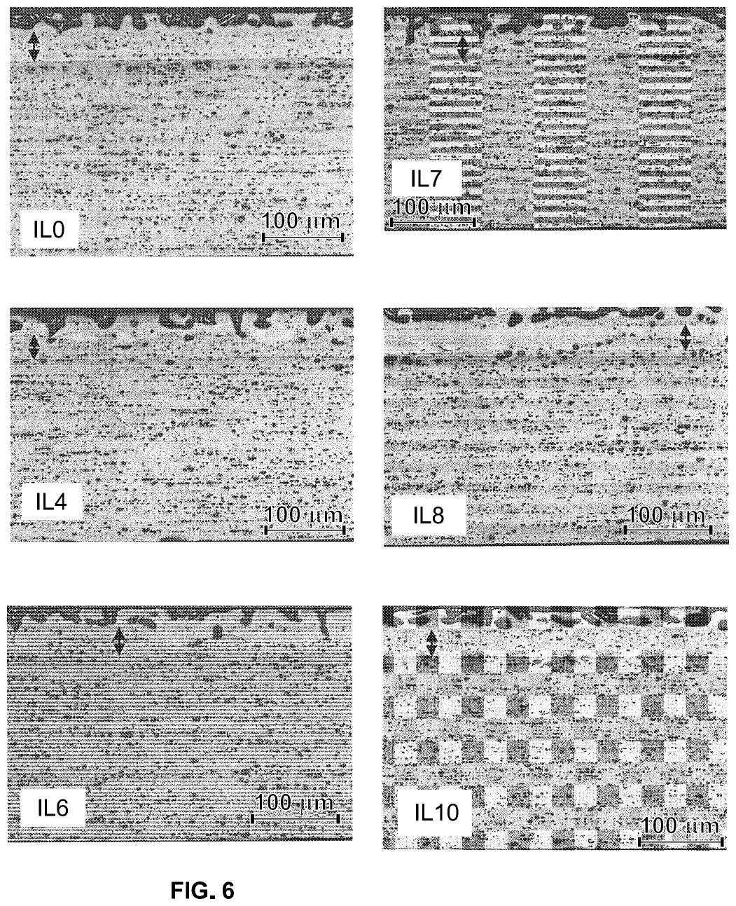

An aspect of the present disclosure is the recognition that when an interliner is used in a brazing sheet with a high strength aluminum alloy, such as a 3XXX series alloy, the interliner tends to experience significant liquid film migration (LFM) during brazing, which can negatively affect corrosion resistance. This is particularly true of O temper materials. Brazing sheet is often supplied in O temper, i.e., after full annealing. O temper brazing sheet exhibits good formability that permits the sheet to be formed into the necessary shapes required for making components, such as EGR type CACs (charge air coolers) and heat exchanger parts, e.g., tubes, end plates, manifolds, collector tanks, etc. It is critical to maintain corrosion protection functions for the interliners when components made of these multilayer materials are exposed to corrosive environments. By forming multilayer sheet material, where O temper is preferred, the forming process may create residual strains in the materials in their formed shapes. It is known that O temper, multilayer brazing sheet with a 3XXX interliner with low residual strain (i.e. <10%) can experience severe LFM during brazing by reacting with brazing filler materials. For this reason, high purity interliner alloys such as 0140 were preferred as they recrystallize early during the brazing cycle and LFM can be prevented. An aspect of the present disclosure is the identification of strengthening elements and their concentration limits to achieve a higher flow stress for improved roll-bonding and also have a much less significant LFM impact on corrosion resistance than, e.g., 3XXX alloy interliners. A further aspect of the present disclosure is to minimize LFM without diminishing corrosion resistance, while at the same time achieving improved roll-bondability. An interliner 16 in accordance with the present disclosure promotes roll bonding while preserving good resistance to LFM, corrosion resistance and brazeability via the braze liner 14. If the interliner 16 were to include strengthening elements such as Mn in excess of 0.34 wt. %, and experience a small amount of strain from a forming process prior to brazing, LFM can change the microstructure and chemical composition of the interliner layer. This is in general not preferred for brazed heat exchanger or other components and is illustrated by IL8 shown in FIG. 6, which showed severe LFM.

The brazing sheet material 10 shown in FIG. 1 would be especially suitable as a material used for making heat exchangers that are used in corrosive environments, such as an EGR type CAC and evaporator heat exchangers. In these applications, the brazing sheet material should be corrosion resistant to withstand exposure to the applicable internal and external fluids, such as air, coolant and exhaust gas, etc. without corroding for a commercially acceptable period of normal use. In addition, the resulting heat exchanger should be strong and light in weight.

### Method of Manufacture—Composition

Various examples of cores, interliners and braze liner having various compositions were prepared. The compositions of the core alloys are shown in Table 1, the compositions for the interliner are shown in Table 2, and the braze liner compositions are shown in Table 3. The alloys identified as “0359” (Table 1) and “0611” (Table 2) are alloys sold by Arconic, Inc. of Pittsburg, Pa., U.S.A.

TABLE 1
Experimental Chemical Compositions of High Strength Core Alloys.

| | Alloy | Si | Fe | Cu | Mn | Mg | Zn | Ti |
|---|---|---|---|---|---|---|---|---|
| Core A | 3003 | 0.6 | 0.7 | 0.05-0.2 | 1.0-1.5 | | 0.1 | |
| Core B | 0359 | 0.2 | 0.35 | 0.4-0.6 | 1.0-1.3 | 0.2-0.3 | 0.05 | 0.1-0.2 |

TABLE 2
Chemical Compositions of Interliner Alloys.

| | Si | Fe | Cu | Mn | Mg | Zn | Ti | Zr |
|---|---|---|---|---|---|---|---|---|
| IL0 | 0.4 | 0.2 | 0.03 | 0.05 | 0.03 | 0.05 | 0.05 | 0 |
| (0140) | | | | | | | | |
| IL1 | 0.4 | 0.2 | 0.2 | 0.05 | 0.03 | 0.05 | 0.05 | 0 |
| IL2 | 0.4 | 0.2 | 0.2 | 0.05 | 0.03 | 0.05 | 0.05 | 0.12 |
| IL3 | 0.4 | 0.2 | 0.1 | 0.1 | 0.03 | 0.05 | 0.05 | 0 |
| IL4 | 0.4 | 0.2 | 0.03 | 0.2 | 0.03 | 0.05 | 0.05 | 0 |
| IL5 | 0.4 | 0.2 | 0.2 | 0.2 | 0.03 | 0.05 | 0.05 | 0 |
| IL6 | 0.4 | 0.2 | 0.03 | 0.3 | 0.03 | 0.04 | 0.05 | 0 |
| IL7 | 0.4 | 0.2 | 0.03 | 0.1 | 0.1 | 0.04 | 0.05 | 0.12 |
| IL8 | 0.4 | 0.2 | 0.2 | 0.2 | 0.15 | 0.05 | 0.05 | 0 |
| IL9 | 0.4 | 0.2 | 0.2 | 0.2 | 0.15 | 0.05 | 0.05 | 0.12 |
| IL10 | 0.4 | 0.2 | 0.03 | 0.05 | 0.4 | 0.04 | 0.05 | 0 |
| (0611) | | | | | | | | |

TABLE 3
Chemical Compositions of Braze Liner Alloys.

| Alloy | Si | Fe | Cu | Mn | Mg | Zn |
|---|---|---|---|---|---|---|
| 4343 | 6.8-8.2 | 0.8 | 0.25 | 0.1 | 0.05 | 0.1 |

In each of the compositions for the core, braze liners and interliners disclosed herein, the composition is an aluminum alloy expressed in weight percent of each listed element with aluminum and impurities as the remainder of the composition, i.e., other element ≤0.05 each and ≤0.15 wt. % total. The compositional ranges of the elements include all intermediate values as if expressed literally herein. For example, in the above composition, Mn in the range of 0.1 to 0.3 wt. % includes, 0.01, 0.02, 0.03, 0.04 . . . , 0.28, 0.29 and 0.30 wt. % and all intermediate values, such as: 0.11, 0.24 wt. %, etc., in increments of 0.01 wt. %.

### Mechanical and Thermal Practices Used in Preparing the Brazing Sheet

The fabrication practice includes, but is not limited to, casting the ingots of the high strength core alloy, the 4XXX braze liner alloy and the interliner alloy of the 3-layer architecture shown in FIG. 1. In some embodiments, the interliner ingot may be subjected to a preheat or homogenization in a temperature range of 450° C. to 550° C. for a soak time of up to 24 hours before rolling into an interliner layer. The high strength core ingot may also be subjected to a similar thermal treatment. In some embodiments, the ingots are not subjected to a thermal treatment before rolling. In some embodiments, the high strength core ingot is not subjected to a thermal treatment before hot rolling. The 3-layer brazing sheets have a braze liner, interliner and a core. The braze liner and interliner can each contribute 5 to 30% of the total thickness of the sheet.

In some embodiments, the stack-up/composite consists of 3 layers that are subjected to a reheat process for hot rolling. The hot rolling temperature has a range of 400° C.-520° C.

In some embodiments, the resultant multilayer composite is cold rolled to an intermediate gauge and then goes through an intermediate anneal at a temperature range of 340° C.-420° C. and soak time up to 8 hours. After intermediate annealing, the composite is again cold rolled to a lighter gauge or a final gauge of 0.1 to 3 mm. In some embodiments, the material may be subjected to more than one intermediate anneal and then rolled to a lighter gauge and then another intermediate anneal. In some embodiments, the material at the final gauge is subject to a final partial anneal or a full anneal in a temperature range of 150° C.-420° C. and a soak time up to 8 hours.

In some embodiments, the composite is cold rolled directly to a final gauge without an intermediate anneal and then subjected to a final partial anneal or a full anneal in a temperature range of 150° C. to 420° C. and soak time up to 8 hours.

### Experimental Results

With added strengthening elements such as Mn, Mg, Cu and Zr, a series of experimental interliner alloys (listed in Table 2) were cast into ingots of dimensions 14″ by 10″ by 2″. Cylindrical coupons (10 mm in diameter and 15 mm long) were prepared from the ingot material after a pre-heat treatment. These coupons were measured for their flow stress at a representative rolling temperature. Core alloys, braze liner 4343 and the base line high purity interliner (IL0) were also measured for comparison. The composition of the core alloys and braze liner are listed in Table 1 and Table 3 above, respectively. In accordance with an aspect of the present disclosure, a smaller difference in flow stress at rolling temperature between these layers promotes roll-bonding especially for the soft interliner layers. Flow stress testing was carried out with a Gleeble thermomechanical Simulator. The tests were done at a temperature of 900° F. (482° C.), which is representative for rolling temperature range (400 to 520° C.) for multilayer brazing sheets. Three strain rates were applied for the flow stress measurements: 0.01, 0.1 and 1/second. These strain rates were selected to cover a wide range of typical reduction for the rolling operation of brazing sheets. Table 4 below lists the flow stress of the relevant alloys at 900° F. measured with stain rates at 0.01. 0.1 and 1/sec, respectively. The flow stress value at each stain rate was calculated by averaging the values between 0.2 to 0.7 true strain from a compression test with the Gleeble thermomechanical simulator.

TABLE 4

| | Flow stress | Flow stress | Flow stress |
|---|---|---|---|
| | ksi0.01/ | ksi0.1/ | Ksi1/ |
| Alloys | second | second | second |
| Core A (3003) | 2.09 | 3.19 | 5.16 |
| Core B (0359) | 4.21 | 5.47 | 7.16 |
| IL0 (0140) | 1.25 | 1.91 | 3.15 |
| IL1 (0.2Cu) | 1.29 | 2.01 | 3.41 |
| IL2 (0.2Cu0.125Zr) | 1.42 | 2.15 | 3.54 |
| IL3 (0.1Cu0.1Mn) | 1.53 | 2.15 | 3.52 |
| IL4 (0.2Mn) | 1.72 | 2.35 | 3.78 |
| IL5 (0.2Cu0.2Mn) | 1.75 | 2.45 | 3.79 |
| IL6 (0.3Mn) | 1.90 | 2.60 | 3.87 |
| IL7 (0.1Mn0.1Mg0.125Zr) | 1.67 | 2.62 | 4.39 |
| IL8 (0.2Cu0.2Mn0.15Mg) | 2.29 | 3.16 | 4.68 |
| IL9 | 2.53 | 3.35 | 4.82 |
| (0.2Cu0.2Mn0.15Mg0.125Zr) | | | |
| IL10 (0611) | 1.72 | 2.70 | 4.45 |
| Braze liner 4343 | 1.70 | 2.62 | 4.55 |

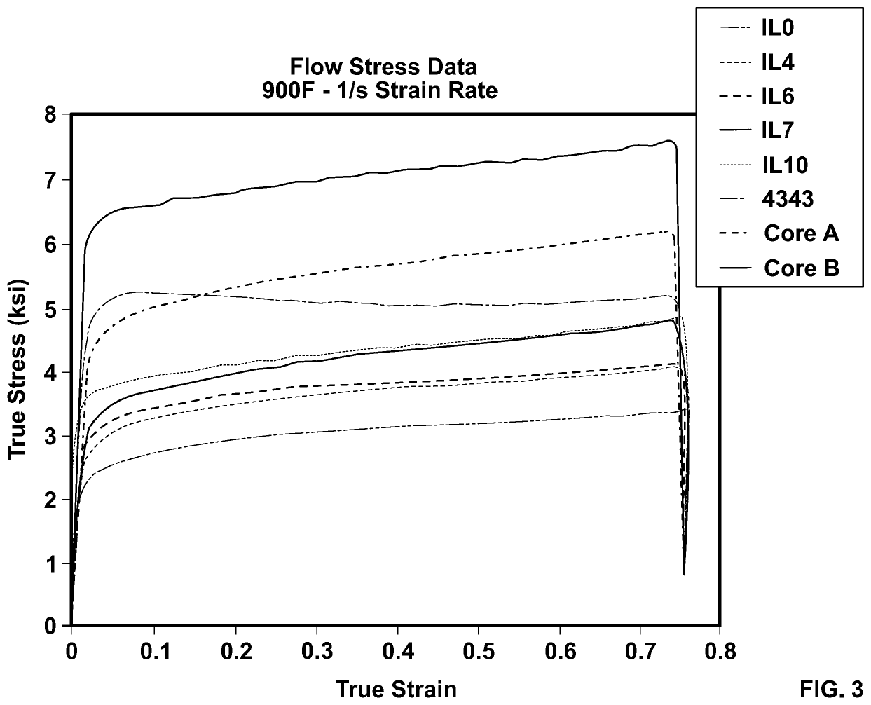

The results recorded in Table 4 are shown in FIG. 3, which shows flow stress curves for the alloys tested with 1/second strain rate at 900° F., the flow stress being averaged by the values between the strain of 0.2 and 0.7.

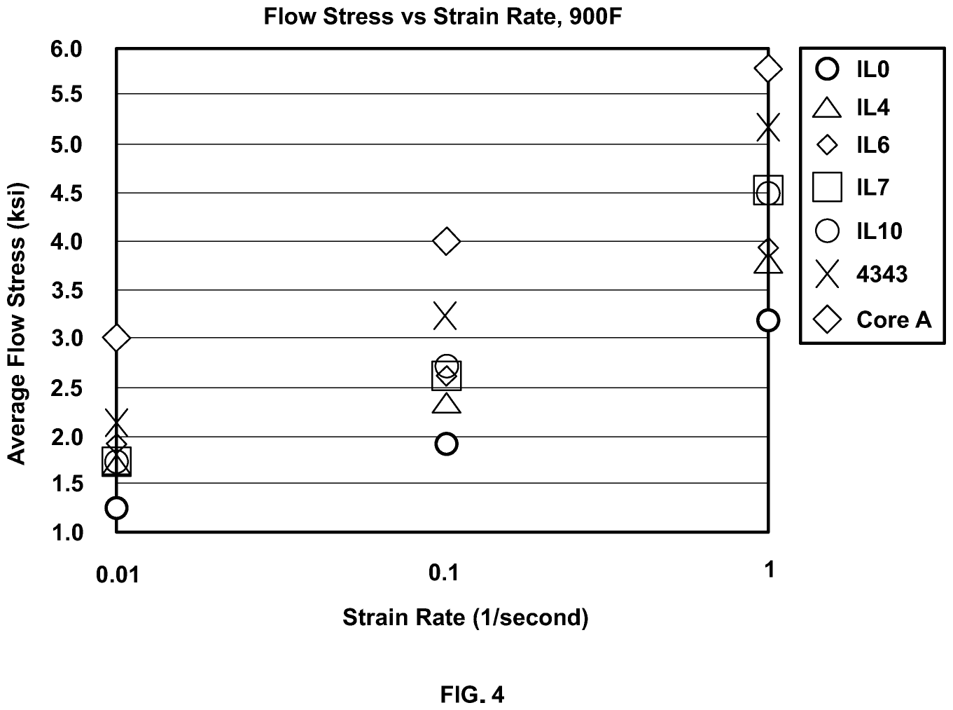

FIG. 4 shows flow stresses of the alloys tested with 0.01, 0.1 and 1/second strain rate at 900° F. The flow stress is averaged by the values between the strain of 0.2 and 0.7 from the tests shown in FIG. 3. The flow stress at a lower strain rate such as 0.01/s and 0.1/s, of interliner alloys in accordance with the present disclosure is similar to the flow stress of braze liner alloy 4343, which promotes good bonding in a slow reduction process, such as that used for roll-bonding of multi-layer braze sheets. The higher stain rate is often applied for the reduction of thickness of a stack-up in the late stage of the rolling process after bonding is already complete.

During roll-bonding, a high purity interliner such as IL0 (0140 alloy) will deform more easily compared to braze layers, such as 4343 (alloy B) and core alloys, such as 3003/0359 (Core alloy A and B), which can often cause delamination, blistering and curvature of multi-layer ingot/plate assemblies. The measured flow stresses of a high purity interliner (IL0, 0140) alloy and a braze liner 4343 and 3003/0359 (Core A and B) are shown in the FIG. 3 with some other materials for comparison. The summarized flow stress values of all experimental alloys are shown in Table 4. The interliner IL4 (0.2 Mn), IL6 (0.3 Mn), IL7 (0.1 Mn 0.1 Mg 0.125 Zr), IL8 alloy (0.2 Mn 0.2 Cu 0.15 Mg) and IL10 (0.4 Mg) showed higher flow stress compared to IL0. In accordance with an embodiment of the present disclosure, interliners with additional strengthening elements, show increased flow stress, and improved roll-bondability. The highest flow stress for the above-described interliner alloys is believed to provide the best performance for roll-bonding. However, in accordance with the present disclosure, the LFM phenomena associated with higher contents of strengthening elements is also taken into consideration, as shown by the assessment of corrosion in the testing described below.

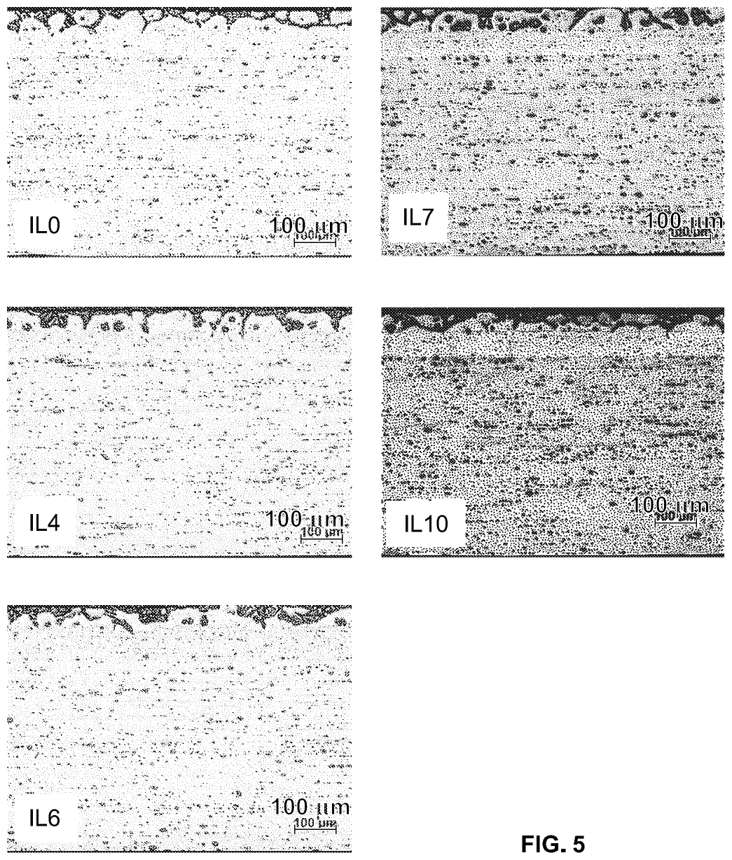

FIG. 5 and FIG. 6 show microstructures of multilayer materials with no pre-strain and 4% pre-strain after a typical CAB brazing cycle, respectively. The brazing cycle includes a 35° C./min heating-up to 577° C. then 12° C./min to 600° C. with a step of 2 minutes at 600° C. Cooling was then carried out in the furnace at about −125° C./min until 250° C., then air-cooled. In FIG. 6, the top and bottom of the interliner are indicated by double arrows. All the interliner alloys without pre-strain before brazing were fully recrystallized during the brazing cycle and no LFM was observed, as shown in FIG. 5. With a 4% pre-strain, LFM can be observed in some experimental materials at various levels of severity in FIG. 6. IL0 and IL10 interliner alloys did not show LFM as the materials fully recrystallized to prevent LFM from happening. IL10 had 0.4 Mg content which can increase flow stress for an easy roll-bond. Alloys IL4, IL6 and IL7 (with 0.2 Mn, 0.3 Mn and 0.1 Mn 0.1 Mg 0.125 Zr respectively) showed LFM, but mostly limited to less than 50% of the original thickness of the interliner IL. The higher alloyed IL8 showed more severe LFM, which affected almost the entire IL layer. It is critical to maintain corrosion protection functions for the interliners when components made of these materials are exposed to corrosive environments. From this perspective, higher alloying contents such as IL8 are not preferred. An aspect of the present disclosure is the recognition that there are limits to the strengthening elements that can be added into interliner alloys, such as 0140 to increase flow stress while maintaining limited effects of LFM. A selection criteria for the interliner alloys of the present disclosure is corrosion resistance.

The corrosion test used to assess the interliner alloys of Table 2 used a solution that was a mixture of sulfuric, nitric, formic and acetic acids with a pH of 2.4 and 50 mg/L sodium chloride. The solution was to simulate an exhaust gas recirculation (EGR) type of environment. Alternating dry (16 hours in the air) and wet (8 hours in the solution) cycles were used for this test method and aeration was applied into the solution for the wet cycle to accelerate the corrosion.

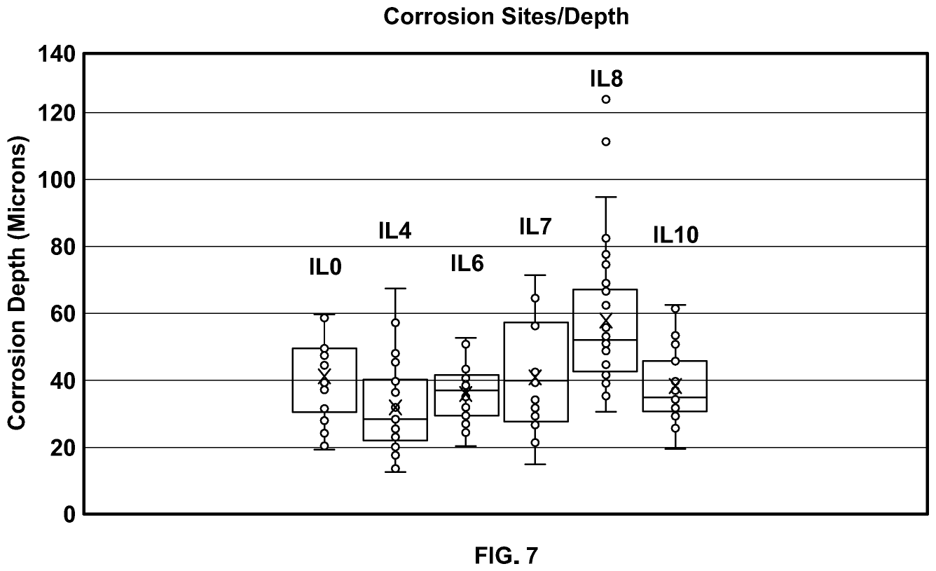

FIG. 7 shows measurement of corrosion pits number and depths after 60 days testing with this method. All the materials have been treated with 4% pre-strain before brazing cycle to simulate significant LFM conditions. The corrosion depth shown in FIG. 7 were measured from the top position of interliner (right below braze liner) to the deepest location of any corrosion sites. The IL4, 6 and 7 are all showed similar corrosion resistance comparing to IL0 and IL10 which both did not have any LFM effects. The IL8, which showed the most severe LFM showed deteriorated corrosion resistance. The results demonstrated that optimized compositions can increase flow stress and also maintain a superior corrosion resistance, as well as provide a high purity interliner (like IL0).

As shown in FIG. 1, a multi-layer brazing sheet includes a layer of brazing liner, an interliner alloy and a core alloy. The brazing liner can be made of 4XXX series aluminum alloys such as 4343 4045 and 4047 alloys. The core alloys can be made of 2XXX, 3XXX and 6XXX alloys such as 3003 alloys. The interliner alloy can be made of high purity aluminum alloy with an optimal amount of Mn and/or Mg, as described above. The experiments showed that addition of 0.15 wt. % Mg up to 0.4 wt. % with or without a small amount of Mn can be made to the same effect of 0.3 wt. % Mn. As up to 5 wt. % zinc will not change the flow stress and LFM behavior for the braze liner and interliners alloys herein, up to 5 wt. % zinc can be added to these alloys for potential corrosion resistance improvements.

The present disclosure utilizes standard abbreviations for the elements that appear in the periodic table of elements, e.g., Mg (magnesium), O (oxygen), Si (silicon), Al (aluminum), Bi (bismuth), Fe (iron), Zn (zinc), Cu (copper), Mn (manganese), Ti (titanium), Zr (zirconium), F (fluorine), K (potassium), Cs (Cesium), etc.

The figures constitute a part of this specification and include illustrative embodiments of the present disclosure and illustrate various objects and features thereof. In addition, any measurements, specifications and the like shown in the figures are intended to be illustrative, and not restrictive. Therefore, specific structural and functional details disclosed herein are not to be interpreted as limiting, but merely as a representative basis for teaching one skilled in the art to variously employ the present invention.

Detailed embodiments of the present invention are disclosed herein; however, it is to be understood that the disclosed embodiments are merely illustrative of the invention that may be embodied in various forms. In addition, each of the examples given in connection with the various embodiments of the invention is intended to be illustrative, and not restrictive.

Throughout the specification and claims, the following terms take the meanings explicitly associated herein, unless the context clearly dictates otherwise. The phrases “in one embodiment” and “in some embodiments” as used herein do not necessarily refer to the same embodiment(s), though it may. Furthermore, the phrases “in another embodiment” and “in some other embodiments” as used herein do not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on”.

Aspects of the invention will now be described with reference to the following numbered clauses:

1. A multi-layer sheet material, comprising:

a core of one of 2XXX, 3XXX, 5XXX or 6XXX aluminum alloy;

a braze liner of 4XXX aluminum alloy; and

an interliner comprising:

0.31-1.0 wt. % Si;

<0.1 wt. % Mg;

0.25-1.0 wt. % Mn;

up to 5.0 wt. % Zn;

up to 0.3 wt. % Fe;

up to 0.2 wt. % Cu;

up to 0.125 wt. % Zr;

other elements ≤0.05 wt. % each and ≤0.15 wt. % total, balance Al.

2. The sheet material of Clause 1, wherein the interliner contains

0.34-0.5 wt. % Si;

<0.05 wt. % Mg;

0.25-0.35 wt. % Mn

≤0.05 wt. % Zn;

≤0.05 wt. % Cu.

3. The sheet material of Clause 1 or Clause 2, wherein the interliner is disposed between the braze liner and the core.

4. The sheet material of Clause 2 or Clause 3, wherein the interliner contains 0.4-0.5 wt. % Si.

5. The sheet material of any of Clauses 2-4, wherein the interliner contains 0.25-0.34 wt. % Mn 6. The sheet material of any of Clauses 1-5, wherein the interliner further comprises 0.05-5.0 wt. % Zn.

7. The sheet material of any of Clauses 1-6, wherein an increase in flow stress in the interliner attributable to the presence of at least one of Mg and Mn is in the range of 20% to 52% over the flow stress in the interliner without the presence of at least one of Mg and Mn.

8. The sheet material of any of Clauses 1-7, wherein the core is a 3003 aluminum alloy.

9. The sheet material of any of Clauses 1-7, wherein the core comprises 0.1 to 1.0 wt. % Si; up to 0.5 wt. % Fe, 0.2 to 1.0 wt. % Cu; 1.0 to 1.5 wt. % Mn, 0.2 to 0.3 wt. % Mg; up to 0.05 wt. % Zn and 0.1 to 0.2 wt. % Ti.

10. The sheet material of any of Clauses 1-9, wherein the braze liner comprises: 6.8 to 8.2 wt. % Si; up to 0.8 wt. % Fe, up to 0.25 wt. % Cu; up to 0.1 wt. % Mn and up to 0.2 wt. % Zn.

11. The sheet material of any of Clauses 1-10, further comprising another liner disposed on the core distal to the interliner and the braze liner.

12. The sheet material of Clause 11, wherein the another liner includes a second braze liner and a second interliner, the second interliner disposed between the core and the second braze liner.

13. The sheet material of Clause 1, wherein the interliner contains 0.34 to 0.5 wt. % Si and up to 0.1 wt. % Zn.

14. The sheet material of Clause 13, wherein the interliner contains <0.05 wt. % Cu.

15. The sheet material of any of Clauses 1-14, wherein the sheet material has a total thickness of from 0.1 mm to 3.0 mm with a core thickness of 0.09 mm to 2.85 mm, the braze liner having a clad ratio of 2.5% to 20% and the interliner having a clad ratio of 2.5 to 20%.

16. The sheet material of any of Clauses 1-15, wherein the sheet material is O temper.

17. A heat exchanger, comprising at least one of a tube, a fin, a header plate or a tank comprising the sheet material of any of Clauses 1-16.

18. A multi-layer sheet material, comprising:

a core of one of 2XXX, 3XXX, 5XXX or 6XXX aluminum alloy;

a braze liner of 4XXX aluminum alloy; and

an interliner comprising:

0.31-1.0 wt. % Si;

0.1-0.5 wt. % Mg;

0.05-0.3 wt. % Mn;

up to 5.0 Wt. % Zn;

other elements ≤0.05 wt. % each and ≤0.15 wt. % total, balance Al.

19. The sheet material of Clause 18, wherein the interliner contains 0.05-5.0 wt. % Zn.

20. A method for making a brazing sheet comprising the steps of:

providing a layer of interliner comprising 0.31-1.0 wt. % Si; <0.1 wt. % Mg; 0.25-1.0 wt. % Mn;

providing a layer of core material selected from one of 2XXX, 3XXX, 5XXX or 6XXX aluminum alloy;

providing a layer of braze liner material of 4XXX aluminum alloy;

stacking the layer of interliner, the layer of core material and the layer of braze liner material into a stack with the interliner disposed between the layer of core material and the layer of braze liner material; and

rolling the stack to form a bonded multi-layer brazing sheet.

While a number of embodiments of the present invention have been described, it is understood that these embodiments are illustrative only, and not restrictive, and that many modifications may become apparent to those of ordinary skill in the art. Further still, the various steps may be carried out in any desired order (and any desired steps may be added and/or any desired steps may be eliminated. All such variations and modifications are intended to be included within the scope of the appended claims.

We claim:

1. A multi-layer sheet material, comprising:
a core of one of 2XXX, 3XXX, 5XXX or 6XXX aluminum alloy;
a braze liner of 4XXX aluminum alloy; and
an interliner comprising:
0.31-1.0 wt. % Si;
<0.1 wt. % Mg;
0.25-1.0 wt. % Mn;
up to 5.0 wt. % Zn;
up to 0.3 wt. % Fe;
up to 0.2 wt. % Cu;
up to 0.125 wt. % Zr;
other elements ≤0.05 wt. % each and ≤0.15 wt. % total, balance Al.

2. The sheet material of claim 1, wherein the interliner contains
0.34-0.5 wt. % Si;
<0.05 wt. % Mg;
0.25-0.35 wt. % Mn
≤0.05 wt. % Zn;
≤0.05 wt. % Cu.

3. The sheet material of claim 1, wherein the interliner is disposed between the braze liner and the core.

4. The sheet material of claim 2, wherein the interliner contains 0.4-0.5 wt. % Si.

5. The sheet material of claim 2, wherein the interliner contains 0.25-0.34 wt. % Mn

6. The sheet material of claim 1, wherein the interliner further comprises 0.05-5.0 wt. % Zn.

7. The sheet material of claim 1, wherein an increase in flow stress in the interliner attributable to the presence of at least one of Mg and Mn is in the range of 20% to 52% over the flow stress in the interliner without the presence of at least one of Mg and Mn.

8. The sheet material of claim 1, wherein the core is a 3003 aluminum alloy.

9. The sheet material of claim 1, wherein the core comprises 0.1 to 1.0 wt. % Si; up to 0.5 wt. % Fe, 0.2 to 1.0 wt. % Cu; 1.0 to 1.5 wt. % Mn, 0.2 to 0.3 wt. % Mg; up to 0.05 wt. % Zn and 0.1 to 0.2 wt. % Ti.

10. The sheet material of claim 1, wherein the braze liner comprises: 6.8 to 8.2 wt. % Si; up to 0.8 wt. % Fe, up to 0.25 wt. % Cu; up to 0.1 wt. % Mn and up to 0.2 wt. % Zn.

11. The sheet material of claim 1, further comprising another liner disposed on the core distal to the interliner and the braze liner.

12. The sheet material of claim 11, wherein the another liner includes a second braze liner and a second interliner, the second interliner disposed between the core and the second braze liner.

13. The sheet material of claim 1, wherein the interliner contains 0.34 to 0.5 wt. % Si and up to 0.1 wt. % Zn.

14. The sheet material of claim 13, wherein the interliner contains <0.05 wt. % Cu.

15. The sheet material of claim 1, wherein the sheet material has a total thickness of from 0.1 mm to 3.0 mm with a core thickness of 0.09 mm to 2.85 mm, the braze liner having a clad ratio of 2.5% to 20% and the interliner having a clad ratio of 2.5 to 20%.

16. The sheet material of claim 1, wherein the sheet material is O temper.

17. A heat exchanger, comprising at least one of a tube, a fin, a header plate or a tank comprising the sheet material of claim 1.

18. A multi-layer sheet material, comprising:
a core of one of 2XXX, 3XXX, 5XXX or 6XXX aluminum alloy;
a braze liner of 4XXX aluminum alloy; and
an interliner comprising:
0.31-1.0 wt. % Si;
0.1-0.5 wt. % Mg;
0.05-0.3 wt. % Mn;
up to 5.0 Wt. % Zn;
other elements ≤0.05 wt. % each and ≤0.15 wt. % total, balance Al.

19. The sheet material of claim 18, wherein the interliner contains 0.05-5.0 wt. % Zn.

20. A method for making a brazing sheet comprising the steps of:
providing a layer of interliner comprising 0.31-1.0 wt. % Si; <0.1 wt. % Mg; 0.25-1.0 wt. % Mn;
providing a layer of core material selected from one of 2XXX, 3XXX, 5XXX or 6XXX aluminum alloy;
providing a layer of braze liner material of 4XXX aluminum alloy;
stacking the layer of interliner, the layer of core material and the layer of braze liner material into a stack with the interliner disposed between the layer of core material and the layer of braze liner material; and
rolling the stack to form a bonded multi-layer brazing sheet.
